(19) United States
(12) Patent Application Publication
(10) Pub. No.: US 2025/0298912 A1
(43) Pub. Date: Sep. 25, 2025

(54) INFORMATION PROCESSING SYSTEM, NON-TRANSITORY COMPUTER-READABLE STORAGE MEDIUM, AND CONTROL METHOD

(71) Applicant: FUJIFILM Business Innovation Corp., Tokyo (JP)

(72) Inventor: Yuki MINAMISAKO, Kanagawa (JP)

(73) Assignee: FUJIFILM Business Innovation Corp., Tokyo (JP)

(21) Appl. No.: 18/785,807

(22) Filed: Jul. 26, 2024

(30) Foreign Application Priority Data
Mar. 25, 2024 (JP) 2024-048713

(51) Int. Cl. G06F 21/60

(52) U.S. Cl. CPC G06F 21/604; G06F 21/608

(57) ABSTRACT

An information processing system includes: a display unit that displays a screen; and a processor, in which the processor is capable of, in response to an input of an instruction from a user currently using the system, temporarily handing over a right to use the system from the user currently using the system to another user during processing for the user currently using the system, and the processor receives processing reservation requests from a plurality of users via a terminal of each user, and displays a screen indicating a request status of another user on the display unit in response to an input of an instruction from the user currently using the system.

### CROSS-REFERENCE TO RELATED APPLICATIONS

This application is based on and claims priority under 35 USC 119 from Japanese Patent Application No. 2024-048713 filed Mar. 25, 2024.

### BACKGROUND

### (i) Technical Field

The present disclosure relates to an information processing system, a non-transitory computer-readable storage medium, and a control method.

### (ii) Related Art

JP1993-134511A (JP H05-134511A) describes a copy interruption control apparatus that quantitatively determines the amount of work in copy processing of an interruption applicant and a current copier, avoids a monopoly of a copy machine by the copier for a long time for copying, performs switching of copy processing conditions associated with interruption processing in a short time, and improves the efficiency of use of the copy machine.

JP2019-126918A describes an image forming apparatus that prevents or remedies a decrease in productivity caused by a user giving up the order of use of the image forming apparatus to another user.

### SUMMARY

Aspects of non-limiting embodiments of the present disclosure relate to an information processing system, a non-transitory computer-readable storage medium, and a control method that makes it possible for a user currently using the system to grasp a request status of another user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising: a display unit that displays a screen; and a processor, wherein the processor is capable of, in response to an input of an instruction from a user currently using the system, temporarily handing over a right to use the system from the user currently using the system to another user during processing for the user currently using the system, and the processor receives processing reservation requests from a plurality of users via a terminal of each user, and displays a screen indicating a request status of another user on the display unit in response to an input of an instruction from the user currently using the system.

### BRIEF DESCRIPTION OF THE DRAWINGS

Exemplary embodiments of the present invention will be described in detail based on the following figures, wherein:

FIG. 1 is a diagram illustrating a system configuration of an image forming system according to an exemplary embodiment of the present disclosure;

FIG. 2 is a block diagram illustrating a hardware configuration of an image forming apparatus according to an exemplary embodiment of the present disclosure;

FIG. 3 is a block diagram illustrating a functional configuration of the image forming apparatus;

FIG. 4 is a diagram illustrating an example of a copy screen on the image forming apparatus;

FIG. 5 is a diagram illustrating an example of a copy screen on the image forming apparatus;

FIG. 6 is a diagram illustrating an example of a screen of a request for use from another user on the image forming apparatus;

FIG. 7 is a diagram illustrating an example of a screen of a request for use from another user on the image forming apparatus;

FIG. 8 is a diagram for describing a flow of processing at the time of handing over a right to use in the image forming apparatus;

FIG. 9 is a diagram for describing a flow of processing at the time of handing over a right to use in the image forming apparatus; and

FIG. 10 is a flowchart for describing a flow of processing at the time of handing over a right to use in the image forming apparatus.

### DETAILED DESCRIPTION

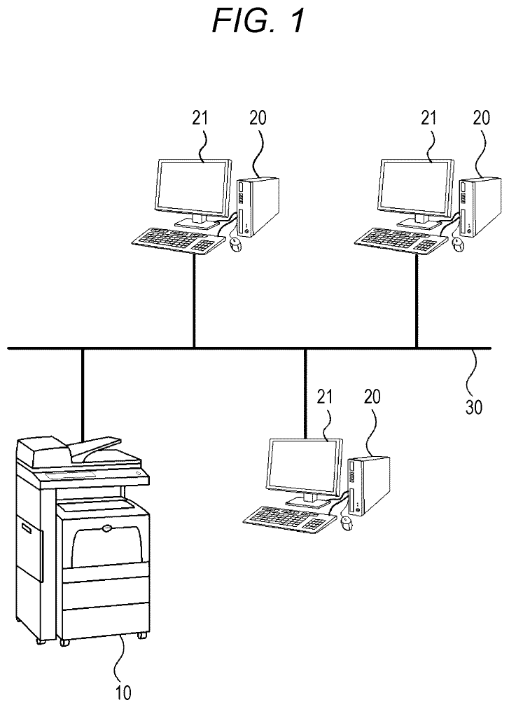

Hereinafter, form examples for carrying out the technology of the present disclosure will be described in detail with reference to the drawings. FIG. 1 is a diagram illustrating a system configuration of an image forming system according to an exemplary embodiment of the present disclosure.

As illustrated in FIG. 1, the image forming system of the present exemplary embodiment includes an image forming apparatus 10, a plurality of user terminals 20, and a network 30.

The image forming apparatus 10 is a so-called multifunction machine having a plurality of functions such as a printing function, a scanning function, a copying function, and a facsimile function. The image forming apparatus 10 is an example of an information processing system in the technology of the present disclosure.

The user terminals 20 are connected to the image forming apparatus 10 via the network 30, and they are terminals for using a function of the image forming apparatus 10. The user terminal 20 includes a display unit 21 that displays a screen.

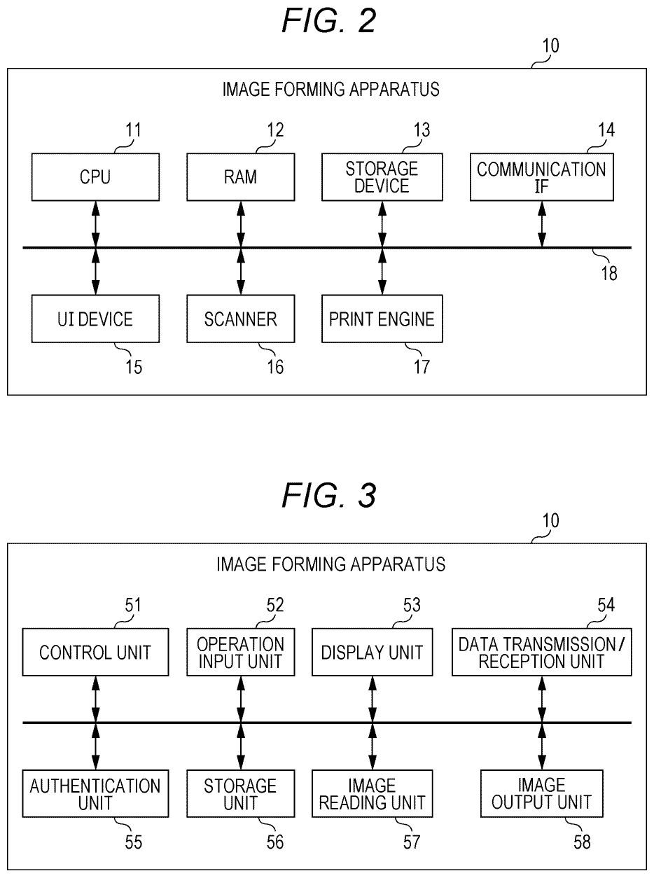

Next, a hardware configuration of the image forming apparatus 10 in a data processing system of the present exemplary embodiment is illustrated in FIG. 2.

As illustrated in FIG. 2, the image forming apparatus 10 includes a central processing unit (CPU) 11, a random access memory (RAM) 12, a storage device 13 such as a hard disk drive, a communication interface (abbreviated as IF) 14, a user interface (abbreviated as UI) device 15, a scanner 16, and a print engine 17. These components are connected to each other via a control bus 18.

The CPU 11 is a processor that executes predetermined processing based on a program stored in the RAM 12 or the storage device 13 to control the operation of the image forming apparatus 10. In this exemplary embodiment, the CPU 11 reads and executes the program stored in the RAM 12 or the storage device 13, but the present disclosure is not limited to this configuration. The program may be provided in a form of being recorded on a computer-readable recording medium. For example, the program may be provided in a form of being recorded in an optical disc such as a compact disc (CD)-read only memory (ROM) or a digital versatile disc (DVD)-ROM, or in a form of being recorded in a semiconductor memory such as a universal serial bus (USB) memory or a memory card. The program may be acquired from an external device via a communication line connected to the communication IF 14.

The communication IF 14 transmits and receives data to and from an external device or the like via the network 30. The UI device 15 includes a touch panel and a physical button in which a predetermined function is set, and receives an input of an instruction from a user. The scanner 16 reads a document loaded in the image forming apparatus 10 as image data. The print engine 17 prints an image on a recording medium, such as a printing paper, through steps such as charging, exposure, development, transfer, and fixing.

FIG. 3 is a block diagram illustrating a functional configuration of the image forming apparatus 10. As illustrated in FIG. 3, the image forming apparatus 10 of the present exemplary embodiment includes a control unit 51, an operation input unit 52, a display unit 53, a data transmission/reception unit 54, an authentication unit 55, a storage unit 56, an image reading unit 57, and an image output unit 58.

The control unit 51 controls the entire operation of the image forming apparatus 10, and it performs control of reading a document image with the image reading unit 57, control of outputting print data from the image output unit 58, and the like based on an input of an instruction from the user.

The operation input unit 52 inputs information of various operations performed by the user. The display unit 53 is controlled by the control unit 51 and displays various information to the user. The data transmission/reception 54 transmits and receives data to and from an external device such as the user terminal 20. The authentication unit 55 executes authentication processing for a user who attempts to use the image forming apparatus 10.

The storage unit 56 stores various kinds of data such as a program for controlling the operation of the image forming apparatus 10. The image reading unit 57 reads a document image from a loaded document based on the control by the control unit 51. The image output unit 58 outputs an image onto a recording medium such as a printing paper based on the control by the control unit 51.

As described above, the image forming apparatus 10 of the present exemplary embodiment is shared by a plurality of users. When such a shared image forming apparatus 10 is continuously used for a long period of time, a user who is using the image forming apparatus 10 may be concerned that how many other users are waiting. Even though the user who is using the image forming apparatus wants to temporarily hand over the right to use to another user with a small use amount, the user cannot check the use amount of each user who is waiting.

To solve such a problem, the control unit 51 of the image forming apparatus 10 of the present exemplary embodiment is capable of, in response to an input of an instruction from a user currently using the image forming apparatus 10, temporarily handing over a right to use the image forming apparatus 10 from the user currently using the image forming apparatus 10 to another user during processing for the user currently using the image forming apparatus 10, and the control unit 51 receives processing reservation requests from a plurality of users via the user terminal 20 of each user, and displays a screen indicating a request status of another user on the display unit 53 in response to an input of an instruction from the user currently using the image forming apparatus 10.

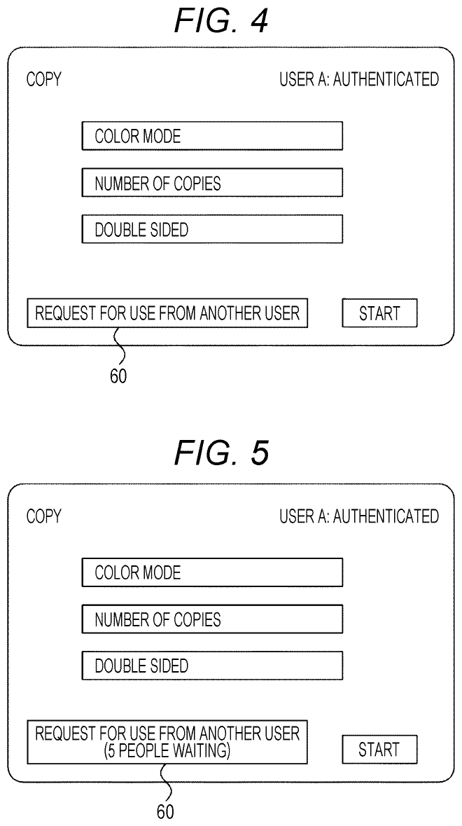

Specifically, as illustrated in FIG. 4, the control unit 51 may display a “REQUEST FOR USE FROM ANOTHER USER” button 60 in an operation screen displayed on the display unit 53 as an operation element for instructing the display of a screen indicating a request status of another user.

In this case, as illustrated in FIG. 5, the control unit 51 may display the number of users waiting for the turn of processing in the “REQUEST FOR USE FROM ANOTHER USER” button 60.

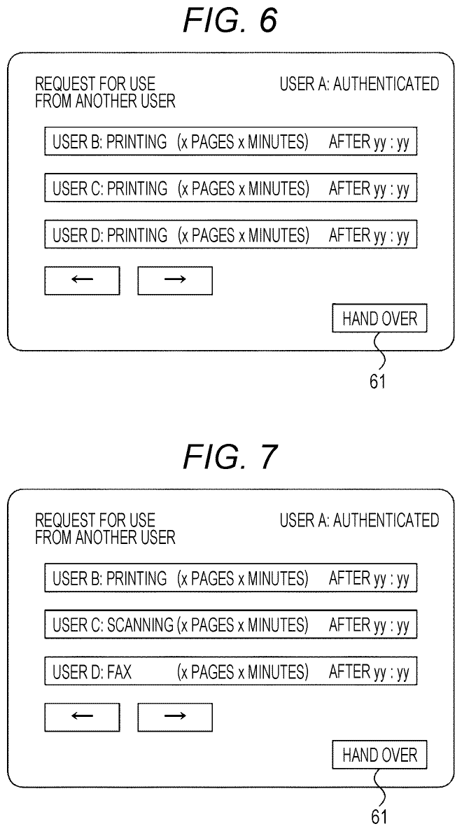

When the [REQUEST FOR USE FROM ANOTHER USER] button 60 is clicked on the operation screen, the control unit 51 displays a [REQUEST FOR USE FROM ANOTHER USER] screen on the display unit 53 as a screen indicating the request status of another user, as illustrated in FIG. 6. Here, a case where printing requests from a plurality of users are received as processing reservation requests will be described.

On the [REQUEST FOR USE FROM ANOTHER USER] screen, information such as a name of the user who has requested a reservation, a processing type (here, printing), the number of sheets to be processed, an estimated processing time, and a reservation time is displayed for each processing reservation request.

The processing reservation request to be received from each user includes request information such as the number of prints, print size, single-sided/double-sided printing, and color mode. The control unit 51 calculates an estimated processing time using the request information, and displays it for each processing reservation request.

The information to be displayed for each processing reservation request is not limited to the above-described information, and another piece of information may be displayed in addition to the above-described information, or some information may be deleted from the above-described information.

The user who are using the apparatus can select a desired user from the “REQUEST FOR USE FROM ANOTHER USER” screen and click a “HAND OVER” button 61 to hand over the right to use to the selected user.

As illustrated in FIG. 7, a processing reservation request other than printing, such as scanning or facsimile, may be received from a plurality of users.

When the [HAND OVER] button 61 is clicked on the [REQUEST FOR USE FROM ANOTHER USER] screen, the control unit 51 notifies the user terminal 20 of the selected user that the right of use has been handed over.

The notification that the right of use has been handed over may be in any form, for example, an indicator indicating that the right to use has been handed over may be displayed on the display unit 21 of the user terminal 20, or the notification may be made by voice from the user terminal 20.

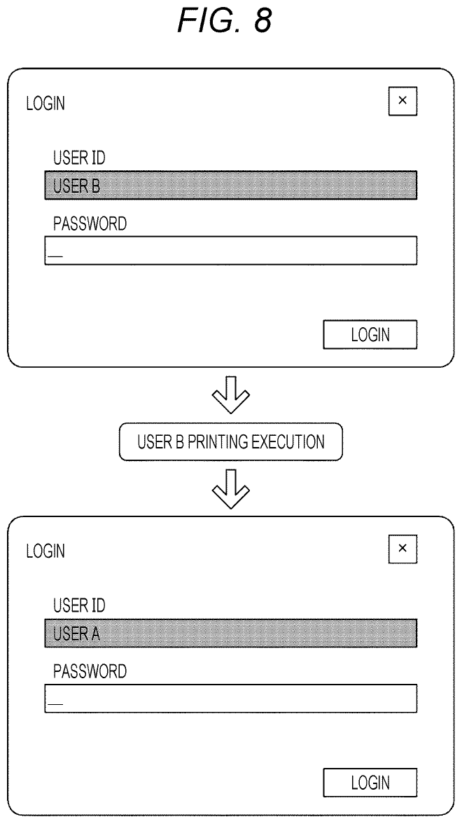

When the right to use has been handed over, the control unit 51 displays an authentication screen dedicated to the user to whom the right to use has been handed over on the display unit 53, as illustrated in FIG. 8. FIG. 8 illustrates, as an example, a case where the right to use has been temporarily handed over from the user A to the user B.

On the authentication screen dedicated to the user to whom the right to use has been handed over, for example, an input portion of the user ID is grayed out so as not to be changed, and only the user to whom the right to use has been handed over can log in.

After the processing for the user to whom the right to use has been handed over is completed, the control unit 51 may display an authentication screen dedicated to the user who has handed over the right to use to the user to whom the right to use has been handed over on the display unit 53. In the example illustrated in FIG. 8, after the processing for the user B to whom the right to use has been handed over is completed, the control unit 51 displays an authentication screen dedicated to the user A who has handed over the right to use to the user B on the display unit 53.

The user authentication method is not limited to input on a login screen, and another authentication method such as authentication of an integrated circuit (IC) card may be used.

In addition, “after the processing for the user to whom the right to use has been handed over is completed” may be immediately after the processing is completed, or may be after a screen for checking whether a document is not left/change is not left or the like is displayed in association with the processing.

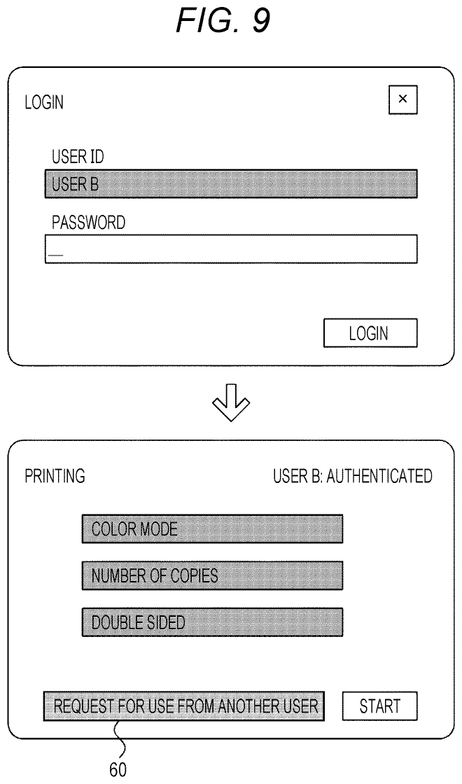

As illustrated in FIG. 9, the control unit 51 may prohibit a change to processing that takes longer processing time than reserved processing reserved by the user to whom the right to use has been handed over while the user to whom the right to use has been handed over is using the system.

In this case, the control unit 51 may prohibit the user to whom the right to use has been handed over from changing the reserved processing to another processing while the user to whom the right to use has been handed over is using the system. In the example illustrated in FIG. 9, on the operation screen, the color mode, the number of copies, and the single-sided/double-sided input portions are grayed out so as not to be changed, so that the processing cannot be changed to another processing.

In addition, as illustrated in FIG. 9, the control unit 51 may prohibit the user to whom the right to use has been handed over from handing over the right to use to another user while the user to whom the right to use has been handed over is using the system. In the example illustrated in FIG. 9, on the operation screen, the [REQUEST FOR USE FROM ANOTHER USER] button 60 for handing the right to use to another user is grayed out so as not to be used.

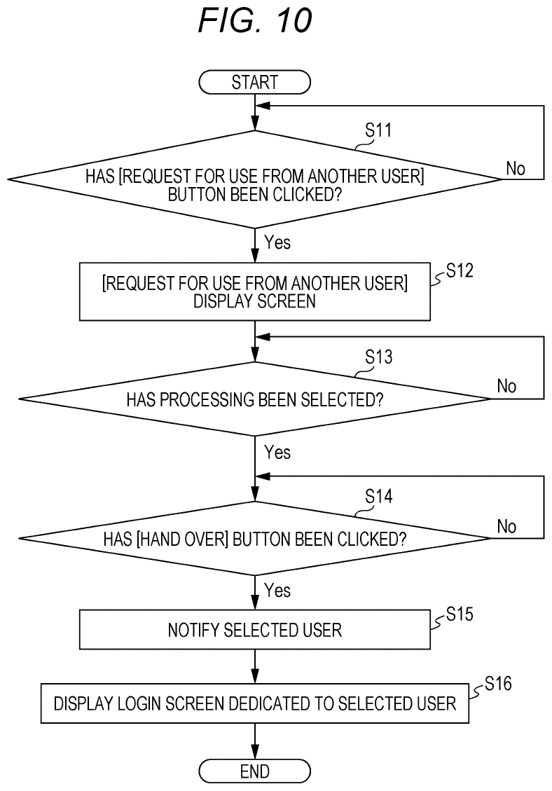

Next, a flow of processing at the time of handing over the right to use in the image forming apparatus 10 of the present exemplary embodiment will be described with reference to the flowchart of FIG. 10.

First, in step S11, the control unit 51 determines whether the “REQUEST FOR USE FROM ANOTHER USER” button 60 has been clicked on the operation screen.

When it is determined in step S11 that the “REQUEST FOR USE FROM ANOTHER USER” button 60 has not been clicked, the control unit 51 repeats the determination in step S11 until it is determined that the “REQUEST FOR USE FROM ANOTHER USER” button 60 has been clicked.

When it is determined in step S11 that the “REQUEST FOR USE FROM ANOTHER USER” button 60 has been clicked, the control unit 51 displays the “REQUEST FOR USE FROM ANOTHER USER” screen on the display unit 53 in step S12.

Next, in step S13, the control unit 51 determines whether processing has been selected on the “REQUEST FOR USE FROM ANOTHER USER” screen.

When it is determined in step S13 that no processing has been selected, the control unit 51 repeats the determination in step S13 until it is determined that processing has been selected.

When it is determined in step S13 that processing has been selected, the control unit 51 determines in step S14 whether the [HAND OVER] button 61 has been clicked on the [REQUEST FOR USE FROM ANOTHER USER] screen.

When it is determined in step S14 that the [HAND OVER] button 61 has not been clicked, the control unit 51 repeats the determination in step S14 until it is determined that the [HAND OVER] button 61 has been clicked.

When it is determined in step S14 that the [HAND OVER] button 61 has been clicked, the control unit 51, in step S15, notifies the user who has requested the processing selected in step S13 that the right to use has been handed over.

Next, in step S16, the control unit 51 displays a login screen dedicated to the selected user on the display unit 53, and ends the processing.

### Modification Example

Although an image forming system according to an exemplary embodiment of the present disclosure has been described above, the technology of the present disclosure is not limited to the exemplary embodiment described above but can be appropriately modified.

In each exemplary embodiment described above, the processor refers to a processor in a broad sense, and it includes general-purpose processors (for example, CPU: central processing unit and the like) and dedicated processors (for example, GPU: graphics processing unit, ASIC: application specific integrated circuit, FPGA: field programmable gate array, programmable logic devices, and the like).

The operation of the processor in each exemplary embodiment described above may be performed not only by one processor but also by a plurality of processors present at physically separated positions in cooperation with each other. The order of the respective operations of the processors is not limited to only the order described in each exemplary embodiment described above but may be appropriately changed.

In the exemplary embodiment described above, the case where the technology of the present disclosure is applied to an image forming apparatus that is a multifunction machine has been described. The present disclosure is not limited to this configuration, but can also be applied to various information processing systems such as a scanner or a printer.

### Supplementary Note

With respect to the exemplary embodiment described above, the following supplementary notes are further disclosed.

(((1)))

An information processing system comprising:
a display unit that displays a screen; and
a processor,
wherein
the processor is capable of, in response to an input of an instruction from a user currently using the system, temporarily handing over a right to use the system from the user currently using the system to another user during processing for the user currently using the system, and
the processor
receives processing reservation requests from a plurality of users via a terminal of each user, and
displays a screen indicating a request status of another user on the display unit in response to an input of an instruction from the user currently using the system.
   (((2)))

The information processing system according to (((1))), wherein
the processor notifies the terminal of a user selected from the screen indicating a request status of another user that the right to use has been handed over.
   (((3)))

The information processing system according to (((2))), wherein
the processor displays, on the display unit, an authentication screen dedicated to the user to whom the right to use has been handed over.
   (((4)))

The information processing system according to (((3))), wherein
after processing for the user to whom the right to use has been handed over is completed, the processor displays, on the display unit, an authentication screen dedicated to the user who has handed over the right to use to the user to whom the right to use has been handed over.
   (((5)))

The information processing system according to any one of (((1))) to (((4))), wherein
the processor displays, on the display unit, an operation element for instructing a display of the screen indicating a request status of another user.
   (((6)))

The information processing system according to (((5))), wherein
the processor displays, in the operation element, the number of users who are waiting for processing.
   (((7)))

The information processing system according to any one of (((1)) to ((6))), wherein
the processor prohibits a change to processing that takes longer processing time than reserved processing reserved by the user to whom the right to use has been handed over while the user to whom the right to use has been handed over is using the system.
   (((8)))

The information processing system according to (((7))), wherein
the processor prohibits a change from the reserved processing reserved by the user to whom the right to use has been handed over to another processing while the user to whom the right to use has been handed over is using the system.
   (((9)))

The information processing system according to any one of (((1))) to (((8))), wherein
the processor prohibits the user to whom the right to use has been handed over from handing over the right to use to another user while the user to whom the right to use has been handed over is using the system.
   (((10)))

A non-transitory computer-readable storage medium storing a program for controlling an information processing system including a display unit that displays a screen,
the program causing a computer to execute processing comprising:
temporarily handing over, in response to an input of an instruction from a user currently using an own system, a right to use the own system from the user currently using the own system to another user during processing of the user currently using the own system;
receiving processing reservation requests from a plurality of users via a terminal of each user; and
displaying a screen indicating a request status of another user on the display unit in response to an input of an instruction from the user currently using the own system.
   (((11)))

A control method comprising:
temporarily handing over, in response to an input of an instruction from a user currently using an own system, a right to use the own system from the user currently using the own system to another user during processing of the user currently using the own system;
receiving processing reservation requests from a plurality of users via a terminal of each user; and
displaying a screen indicating a request status of another user on a display unit of the own system in response to an input of an instruction from the user currently using the own system.

What is claimed is:

1. An information processing system comprising:
a display unit that displays a screen; and
a processor,
wherein
the processor is capable of, in response to an input of an instruction from a user currently using the system, temporarily handing over a right to use the system from the user currently using the system to another user during processing for the user currently using the system, and
the processor
receives processing reservation requests from a plurality of users via a terminal of each user, and
displays a screen indicating a request status of another user on the display unit in response to an input of an instruction from the user currently using the system.

2. The information processing system according to claim 1, wherein
the processor notifies the terminal of a user selected from the screen indicating a request status of another user that the right to use has been handed over.

3. The information processing system according to claim 2, wherein
the processor displays, on the display unit, an authentication screen dedicated to the user to whom the right to use has been handed over.

4. The information processing system according to claim 3, wherein
after processing for the user to whom the right to use has been handed over is completed, the processor displays, on the display unit, an authentication screen dedicated to the user who has handed over the right to use to the user to whom the right to use has been handed over.

5. The information processing system according to claim 1, wherein
the processor displays, on the display unit, an operation element for instructing a display of the screen indicating a request status of another user.

6. The information processing system according to claim 5, wherein
the processor displays, in the operation element, the number of users who are waiting for processing.

7. The information processing system according to claim 1, wherein
the processor prohibits a change to processing that takes longer processing time than reserved processing reserved by the user to whom the right to use has been handed over while the user to whom the right to use has been handed over is using the system.

8. The information processing system according to claim 7, wherein
the processor prohibits a change from the reserved processing reserved by the user to whom the right to use has been handed over to another processing while the user to whom the right to use has been handed over is using the system.

9. The information processing system according to claim 1, wherein
the processor prohibits the user to whom the right to use has been handed over from handing over the right to use to another user while the user to whom the right to use has been handed over is using the system.

10. A non-transitory computer-readable storage medium storing a program for controlling an information processing system including a display unit that displays a screen,
the program causing a computer to execute processing comprising:
temporarily handing over, in response to an input of an instruction from a user currently using an own system, a right to use the own system from the user currently using the own system to another user during processing of the user currently using the own system;
receiving processing reservation requests from a plurality of users via a terminal of each user; and
displaying a screen indicating a request status of another user on the display unit in response to an input of an instruction from the user currently using the own system.

11. A control method comprising:
temporarily handing over, in response to an input of an instruction from a user currently using an own system, a right to use the own system from the user currently using the own system to another user during processing of the user currently using the own system;
receiving processing reservation requests from a plurality of users via a terminal of each user; and
displaying a screen indicating a request status of another user on a display unit of the own system in response to an input of an instruction from the user currently using the own system.
